(19) United States
(12) Patent Application Publication
(10) Pub. No.: US 2006/0212840 A1
(43) Pub. Date: Sep. 21, 2006

(54) Method and system for efficient use of secondary threads in a multiple execution path processor

(76) Inventors: Danny Kumamoto, Cedar Park, TX (US); Michael N. Day, Round Rock, TX (US)

Correspondence Address: SPRINKLE IP LAW GROUP, 1301 W. 25TH STREET, SUITE 408, AUSTIN, TX, 78705, US

(21) Appl. No.: 11/082,040

(22) Filed: Mar. 16, 2005

(51) Int. Cl. G06F 9/44

(52) U.S. Cl. 717/100

(57) ABSTRACT

Systems and methods for the efficient utilization of threads in a processor with multiple execution paths are disclosed. These systems and methods alleviate the need to perform context switching in one or more threads while simultaneously allowing these threads to run useful tasks. One or more of these threads may run tasks in a privileged mode, thus there may be no need to save and restore context in these threads. Additionally, by keeping the threads executing in privileged mode at a lower priority, these privileged mode tasks can run exclusively on one or more of these threads without significantly delaying the execution of other threads.

### TECHNICAL FIELD OF THE INVENTION

The invention relates in general to methods and systems for allocating processor resources, and more particularly, to efficient use of threads in a processor with multiple execution paths.

### BACKGROUND OF THE INVENTION

With the advent of the computer age, electronic systems have become a staple of modern life, and some may even deem them a necessity. Part and parcel with this spread of technology comes an ever greater drive for more functionality from these electronic systems. To accommodate this desire for increased functionality, these systems may employ high performance processors.

These high performance processors, in turn, are increasingly adding complex features to increase their performance. One technique for increasing the performance of processors is partitioned multiprocessor programming (PMP) or a meta-operating system, such as Sun's N1 or IBM's “Hypervisor”. As used herein, the term hypervisor will be used to refer to any and all embodiments of partitioned multiprocessor programming. This allows redundancy to be implemented, such that if applications running on one operating system crash the operating system, other applications running on a different operating system will not be affected. Intel's Vanderpool technology allows similar partitioning or virtualization of the processor to allow multiple instances of operating system(s) to run on the single hardware.

This feature may allow multiple instances of an operating system to run on a processor by creating logical partitions in the processor and allowing an instance of an operating system to utilize a logical partition while a separate instance of an operating system utilizes another logical partition. These operating system instances may call hypervisor functions for certain tasks such as physical memory management, debug register and memory access, virtual device support etc. In most cases, processors designed to implement multiple instances of operating systems as described, have a hypervisor (or similar) mode of operation (in addition to a user mode and supervisor mode) set by a bit in a state register to prevent privileged OS code in one partition from accessing resources or data in another partition.

Another recent development which has increased the performance of modern processors is hardware multi-threading, which allows a processor to execute more than one thread simultaneously. Hardware multi-threading allows two or more hardware pipelines in a processor to execute instructions. Multi-threading as used herein will refer to hardware multi-threading in all its forms. Note that hardware multi-threading does not preclude any type of software multi-threading.

Multithreaded processors can help alleviate some of the latency problems brought on by DRAM memory's slowness relative to the processor. For instance, consider the case of a multithreaded processor executing two threads. If the first thread requests data from main memory and this data aren't present in the cache, then this thread could stall for many processor cycles while waiting for the data to arrive. In the meantime, however, the processor could execute the second thread while the first one is stalled, thereby keeping the processor's pipeline full and getting useful work out of what would otherwise be dead cycles.

Multi-threading can help immensely in hiding memory latencies, and allows the scheduling logic maximum flexibility to fill execution slots, thereby making more efficient use of available execution resources by keeping the execution core busier. In many implementations of multi-threading, threads may be assigned priorities, such that a lower priority thread executes substantially when a higher priority thread would stall the processor.

The combination of these various performance enhancing features, however, may actually degrade the performance of a processor. In particular, interrupt handling may become difficult as control may have to be passed from one operating system to another on a multitude of threads, requiring extra overhead for the saving and restoring of contexts and synchronization of threads, especially if the hardware requires that all threads run the same instance of the operating system.

Thus, a need exists for efficient utilization of threads in a processor with multiple execution paths which reduces the overhead associated with context switching between threads.

### SUMMARY OF THE INVENTION

Systems and methods for the efficient utilization of threads in a processor with multiple execution paths are disclosed. These systems and methods may alleviate the need to perform context switching in one or more threads while simultaneously allowing these threads to run useful applications. One or more of these threads may run applications in a privileged mode, thus there is no need to save and restore context in these threads. Additionally, by keeping the threads executing in privileged mode at a lower priority, these privileged mode applications can run exclusively on one or more of these threads without significantly delaying the execution of other threads.

In one embodiment, a first thread runs a first operating system and a second operating system and a second thread, runs exclusively in hypervisor mode.

In another embodiment, a first thread runs a first operating system and a second operating system and a second thread runs the first operating system and the second operating system and while an interrupt is being handled in the first thread the second thread executes in hypervisor mode or alternately is suspended for the duration of the interrupt processing.

In one embodiment, the second thread is lower priority than the first thread.

In one embodiment, the second thread runs a hypervisor application.

In one embodiment, the hypervisor application is a security check application, an encryption application, a decryption application, a compression application, a decompression application, a reliability test application, a performance monitoring application or a debug monitoring application.

In one embodiment, the first thread passes the hypervisor system call to the second thread using a shared memory.

In one embodiment, the first thread passes the hypervisor system call to the second thread by generating an internal interrupt from the first thread to the second thread.

In one embodiment, the second thread may run a trusted interpreter.

In one embodiment, handling the interrupt includes switching between the first operating system and the second operating system.

In one embodiment, the second thread runs a hypervisor task while the first thread is handling the interrupt.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts an illustration of one embodiment the operation of a hypervisor system.

FIG. 2 depicts an illustration of one embodiment of the operation of a multi-threaded system.

FIG. 3 depicts an illustration of one embodiment of the operation of a system utilizing both a hypervisor and multi-threading.

FIG. 4 depicts an illustration of one embodiment of the operation of the system depicted in FIG. 3 during an interrupt.

FIG. 5 depicts an illustration of another embodiment of the operation of the system depicted in FIG. 3 during an interrupt.

FIG. 6 depicts an illustration of the operation of one embodiment of a system for efficiently utilizing a secondary thread.

FIG. 7 depicts an illustration of the use of thread prioritization with an embodiment of a system for efficiently utilizing a secondary thread.

FIG. 8 depicts an illustration of the operation of another embodiment of a system for efficiently utilizing a secondary thread.

FIG. 9 an illustration of the operation of yet another embodiment of a system for efficiently utilizing a secondary thread.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

Reference is now made in detail to the exemplary embodiments of the invention, examples of which are illustrated in the accompanying drawings. Wherever possible, the same reference numbers will be used throughout the drawings to refer to the same or like parts (elements).

A few terms are defined or clarified to aid in an understanding of the terms as used throughout the specification. The term “hypervisor” is intended to mean any software, hardware or combination which supports the ability to execute two or more operating systems (identical or different) on one or more logical or physical processing unit, and which may oversee and coordinate this functionality.

Attention is now directed to systems and methods for the efficient utilization of threads in a processor with multiple execution paths. These systems and methods may alleviate the need to perform context switching in one or more threads while simultaneously allowing these threads to run useful tasks. One or more of these threads may run tasks in a privileged mode, thus there is no need to save and restore problem state context in these threads. Additionally, by keeping these threads at a lower priority, these privileged mode tasks can run exclusively on one or more of these threads without significantly delaying the execution of other threads.

These systems and methods may work especially efficiently when the two threads can share a cache but where the hardware limits or controls the “thrashing” of the cache by reducing the interference of one threads access pattern with another thread. If the multiple hardware threads are utilized for completely different tasks, such as described here, a partitioned cache may be used to prevent cache thrashing between the multiple threads. In one possible embodiment, cache lines would be tagged with thread id, and the low priority thread would be restricted on the number of cache lines it could utilize exclusively. Cache lines that showed access by multiple threads would not be restricted. This technique would prevent “priority inversion” from occurring. Priority inversion in this case is where the lower priority threads utilization of shared resources (in this case cache lines or translation lookaside buffers) causes increased misses by the higher priority thread. This in turn causes the higher priority thread to stall more often, thus giving more dispatch cycles to the lower priority thread.

Each thread can also have its own ID so that non-cacheable accesses can utilize the specific bandwidth allocated for that thread. This may prevent over-utilization of shared bus bandwith by the lower priority threads.

As mentioned above, many techniques for increasing the performance of modern day processors have been implemented. Before discussing embodiments of the present invention it will be helpful to discuss these various performance enhancing mechanisms.

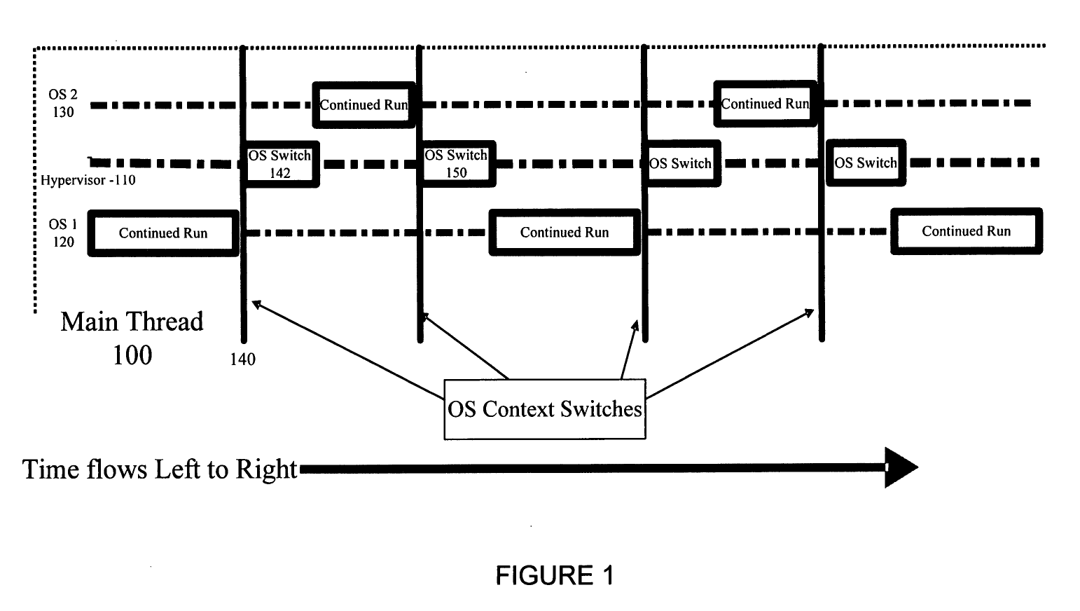

FIG. 1 illustrates the use of a hypervisor with a processor. In one embodiment, a processor may be a single threaded processor executing main thread 100. Hypervisor 110 may be hardware, software, or a combination of the two which supervises the execution of a first operating system (OS) 120 and a second OS 130. Initially, the processor may be executing the first OS 120. At some point 140, hypervisor 110 may initiate OS switch 142, causing the context of first OS 120 to be saved and the context of second OS 130 to be restored. The processor then executes the second OS 130 for a period of time until hypervisor 110 initiates another OS switch 150. During OS switch 150, the context of second OS 130 will be saved and the context of first OS 120 restored. The processor can then execute first OS 120 for a period of time. In this manner, hypervisor 110 may control the execution of first OS 120 and second OS 130. Conversely, first OS 120 and second OS 130 may make Hypervisor calls (hcalls) to hypervisor 110 when an OS 120, 130 needs a service executed on its behalf. It will be understood that a 3^{rd}, 4^{th} or nth OS can be similarly supported in one thread, depending on the ability of the Hypervisor to manage multiple operating systems.

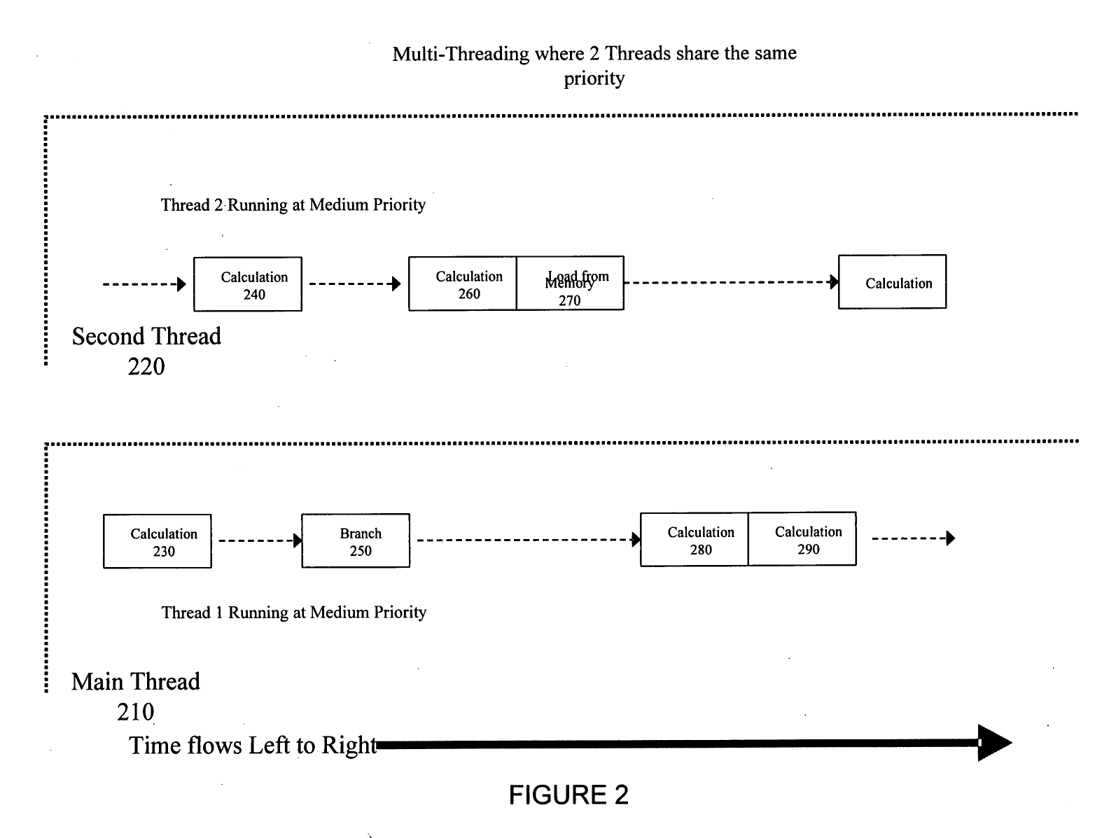

Turning to FIG. 2, the use of multi-threading to better utilize the available resources of a processor is illustrated. A processor may be designed to execute two threads, a main thread 210 and a second thread 220, and to switch between the two threads 210, 220 depending on the activities of each thread 210, 220 or some other criteria, such as a long data load or branch stall. In one embodiment, main thread 210 and second thread 220 may be executing at the same priority level, and processor may be executing main thread 210. Main thread may execute calculation 230, second thread may then execute calculation 240. Main thread executes branch 250, however, branch 250 may take more than one instruction cycle to complete. Instead of waiting for branch 250 to complete, processor may execute instructions for second thread 220, including calculation 260 and load 270. Similarly, during load 270 processor may execute calculations 280, 290 from main thread 210. In this manner, the resources of a processor may be utilized more effectively than by executing only one thread alone.

In certain cases, these threads 210, 220 may be prioritized. For example, main thread 210 may have a higher priority than second thread 220. If main thread 210 is a higher priority than second thread 220, main thread 210 may run until its time slice expires, or until continued running of main thread 210 would cause starvation at the processor, at which point a thread scheduler may switch to execution of second thread 220. It will be apparent that certain processors may have the ability to execute more than two threads and the principles presented herein can be extended to cover beyond two threads.

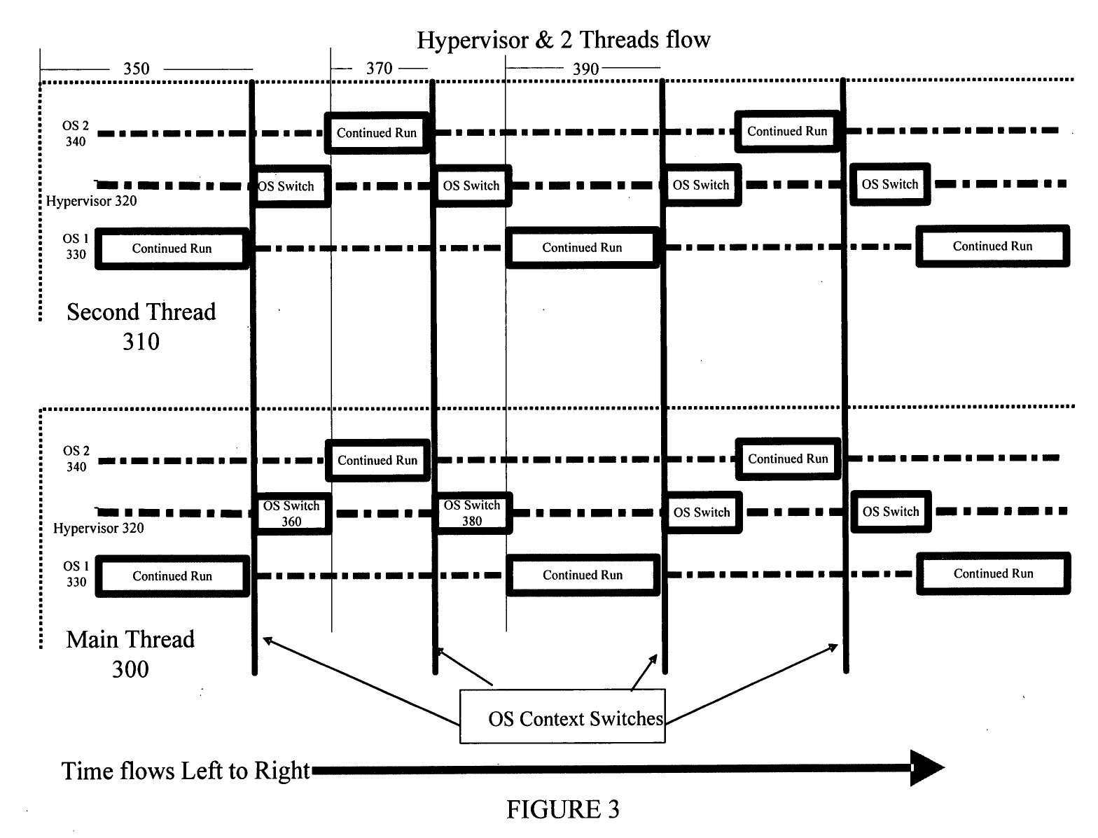

The combination of the multi-threading and hypervisor technologies described with respect to FIGS. 1 and 2 has resulted in powerful yet compact system. The combination of these two technologies is illustrated in FIG. 3. A processor may be capable of executing two threads, main thread 300 and second thread 310. Each of these threads 300, 310 may in turn be running hypervisor 320, operable to supervise the execution of first OS 330 and second OS 340. In one embodiment, hardware requirements may force each thread 310, 320 to run the same operating system 330, 340 simultaneously. Thus, during a first time period 350, both main thread 300 and second thread 310 may be running first OS 330.

At some point, hypervisor 320 running in first thread 300 may initiate an OS switch 360, causing not only main thread 300 to run second OS 340, but additionally causing hypervisor 320 of second thread 310 to switch operating systems such that both main thread 300 and second thread 310 run second OS 340 during time period 370. Similarly, when hypervisor 320 running in main thread 300 initiates OS switch 380 both threads will then execute first OS 320, for the next time period 390.

The mixing of these technologies is difficult, however, as the handling of interrupts becomes more complicated when hypervisor software is run on a multi-threaded processor, since interrupt handling may have to be passed from one OS to another, and an interrupt may occur in any of the threads executing on the processor.

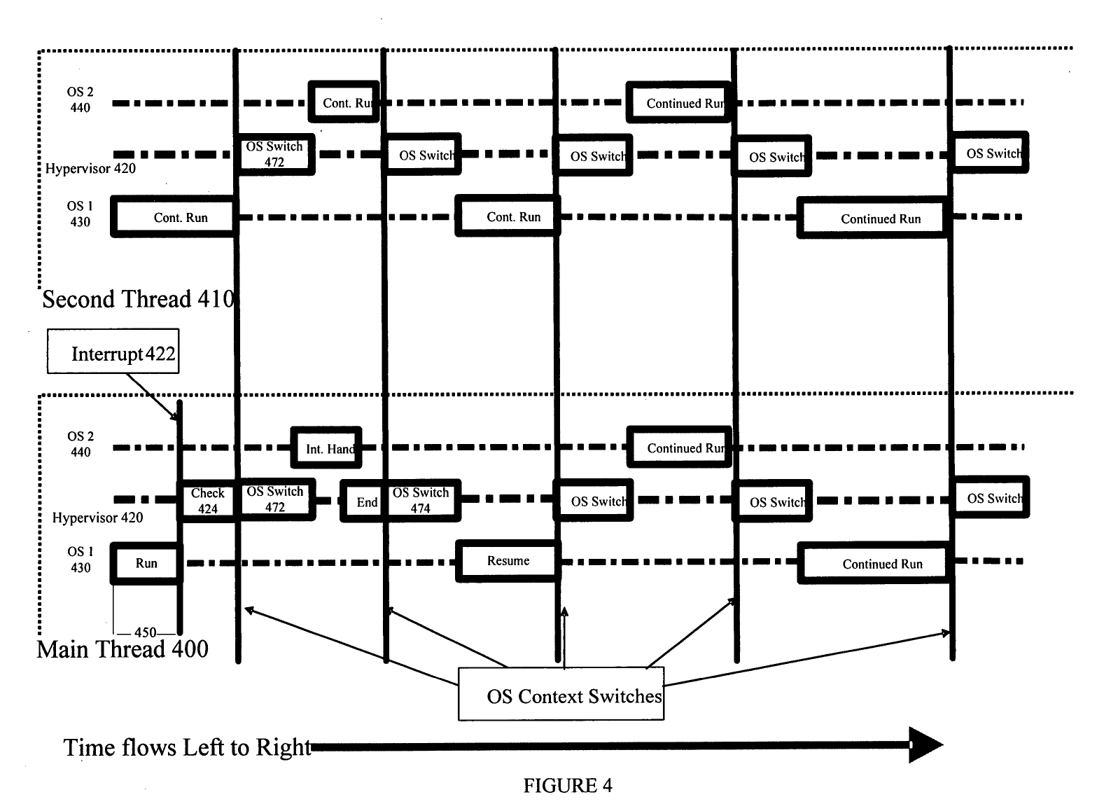

These difficulties are illustrated in the scenario depicted in FIG. 4. Again, a processor may be capable of executing two threads, main thread 400 and second thread 410. Each of these threads 400, 410 is in turn running hypervisor 420, operable to supervise the execution of first OS 430 and second OS 440. In one embodiment, hardware requirements may force each thread 400, 410 to run the same operating system 430, 440 simultaneously. Thus, during a first time period 450, both main thread 400 and second thread 410 may be executing first OS 430.

At some point, hypervisor 420 running in main thread 400 may receive interrupt 422, for example from an I/O device. Hypervisor 420 then checks 424 to determine the intended recipient of interrupt 422. Suppose now that interrupt 422 is intended for second OS 440 executing on main thread 400. Hypervisor 420 initiates OS switch 472 after which the interrupt handler corresponding to interrupt 422 can be run by second OS 440. Hypervisor 420 may then initiate another OS switch 474 and resume executing first OS 430.

However, as the hardware requires both threads 400, 410 to execute the same OS 430, 440; when hypervisor 420 initiates OS switch 472 in main thread 400, second thread 410 must also execute OS switch 472. Thus, there is a great deal of overhead processing required to not only route interrupt 422 but also to switch contexts of operating systems 430, 440 for threads 400, 410 including the extra overhead to synchronize threads 400, 410 before each OS switch 472, 474.

Additionally, the execution time of the interrupt handler in main thread 400 is so short that there is little time to run any useful programs in second OS 440 of second thread 410. In fact, due to the need to synchronize the two threads 400, 410 after an OS switch 472, 474, it might have actually been more efficient not to switch operating systems 430, 440 on second thread during handling of interrupt 422 in main thread 400 or to suspend the execution of thread 410 for the duration of the interrupt handling of the main thread in second OS 440.

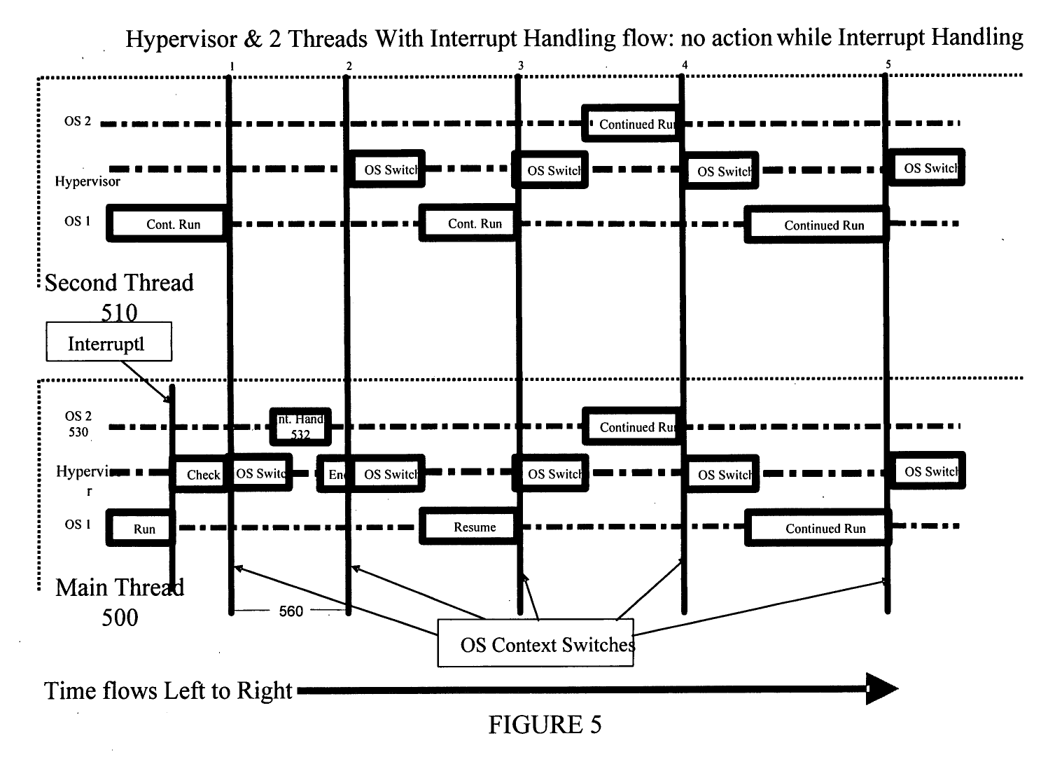

As shown in FIG. 5, however, this solution has its own drawbacks. Namely, during the time period 560 when main thread 500 is switching to second OS 530 and running interrupt handler 532, no instructions are executed by second thread 510, wasting processor resources.

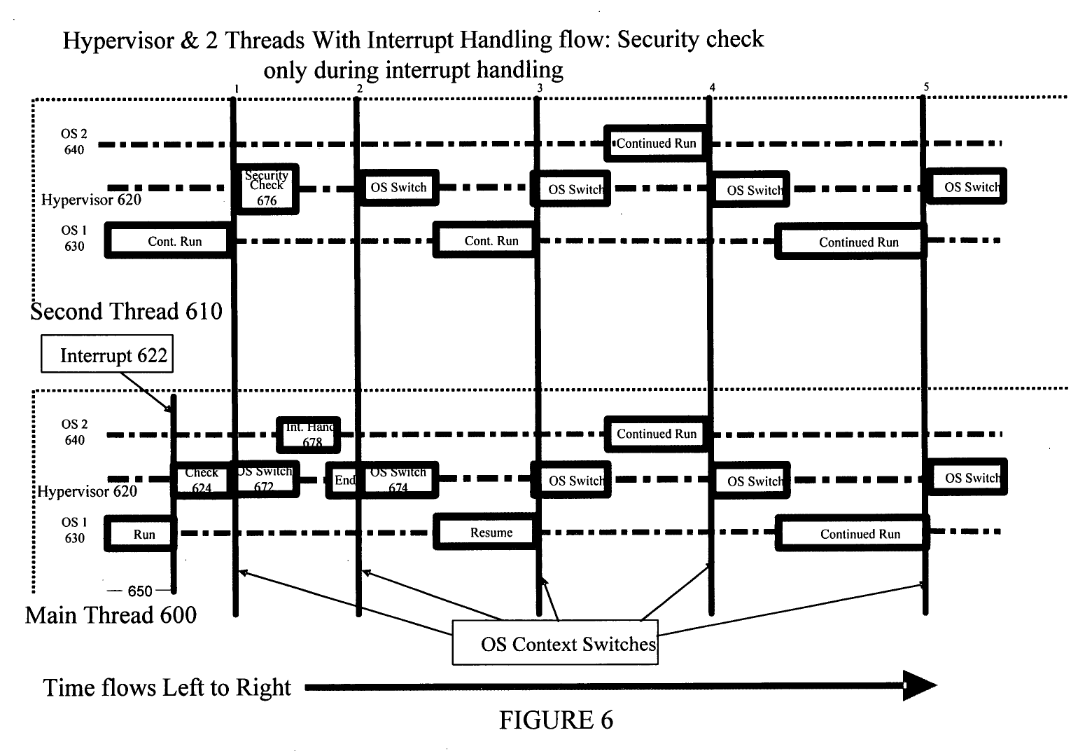

FIG. 6 depicts one embodiment of a system and method for alleviating these wasted resources through the efficient utilization of threads. A processor may be capable of executing two threads, main thread 600 and second thread 610. Each of these threads 600, 610 is in turn running hypervisor 620, operable to supervise the execution of first OS 630 and second OS 640. In one embodiment, hardware requirements may dictate that threads 600, 610 execute the same OS 630, 640 if both threads 600, 610 are executing an OS. Thus, during a first time period 650, both main thread 600 and second thread 610 may be executing first OS 630.

At some point, hypervisor 620 running in main thread 600 may receive interrupt 622, for example from an I/O device. Hypervisor 620 then checks 624 to determine the intended recipient of interrupt 622. Suppose now that interrupt 622 is intended for second OS 640 executing on main thread 600. Hypervisor 620 initiates OS switch 672 after which interrupt handler 678 corresponding to interrupt 622 can be run by second OS 640. Hypervisor 620 may then initiate another OS switch 674 and resume executing first OS 630.

However, when hypervisor 620 initiates OS switch 672 in main thread 600, second thread 610 may be signaled the cause of OS switch 672, in this case that interrupt 622 for second OS 640 has occurred. Upon receiving this signal, second thread 610 may execute software in hypervisor mode while main thread is handling interrupt 622 rather than switch operating systems to run supervisor or user applications. In one embodiment, second thread 610 may run hypervisor mode security check 676, though it is possible to run any hypervisor mode software, as is know in the art, such as security checks (CRC generation etc.), encryption, decryption, compression, decompression, reliability testing, performance monitoring, debug monitoring etc. By running hypervisor mode software during interrupt handling, such as security check 476, there is no need for second thread 610 to change context for an OS switch, thus eliminating the overhead required for the synchronization of second thread 610 and the saving and restoration of context. Similarly, when main thread 600 initiates OS switch 674 and resumes executing first OS 630, second thread 610 may also resume executing first OS 630 without any need to restore a saved context (of OS 630 to replace the context of OS 640). Furthermore, by assigning second thread 610 a lower priority than main thread 600, second thread 610 will run with fewer dispatch slots than the main thread, and will therefore cause a minimal amount of disruption to main thread 600 and give the maximum amount of CPU cycles to main thread 600 in order to finish processing interrupt handler 678 as quickly as possible.

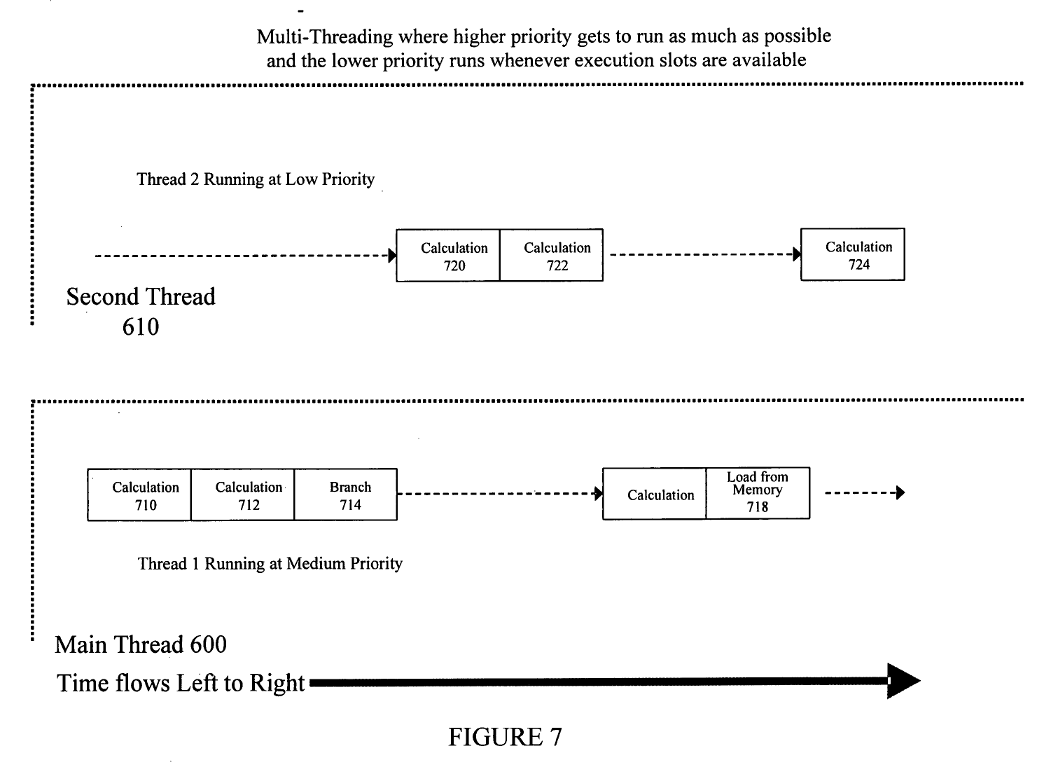

This thread prioritization is depicted more clearly in FIG. 7. Main thread 600 may be running interrupt handler 678 at medium priority, while second thread 610 is executing security check 676 at a low priority. Thus, when main thread 600 is issuing instructions 710, 712, 714, second thread 610 is idle. However, main thread 600 may issue an instruction which requires multiple processor cycles to complete but does not require the processor itself, such as branch instruction 714 or load instruction 718. While waiting for these instructions 714, 718 to complete, main thread 600 is idle. Consequently, during times when main thread 600 would otherwise be idle second thread 610, at a lower priority, may execute instructions 720, 722, 724 for security check 676. In this manner, second thread 610 at low priority may still run security check 676 in hypervisor mode, while providing maximum execution cycles to medium priority main thread 600 for execution of interrupt handler 678.

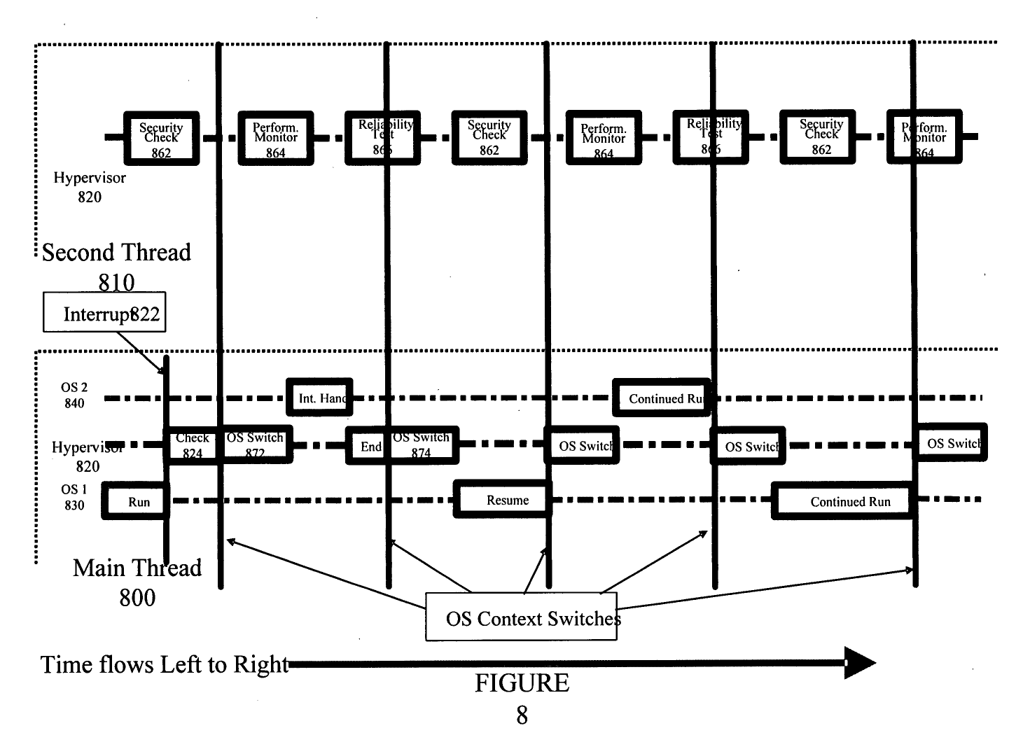

This concept may be taken a step further by having a second thread running exclusively hypervisor mode trusted software. FIG. 8 depicts such an embodiment, where a second thread is devoted to running only hypervisor mode tasks. A processor may be capable of executing two threads, main thread 800 and second thread 810. Each of these threads 800, 810 is in turn running hypervisor 820. In one embodiment, main thread 800 also runs first OS 830 and second OS 840 which are supervised by hypervisor 420. Second thread 610 runs exclusively in hypervisor mode and executes hypervisor tasks, including security check, 862, performance monitor 864, reliability testing 866. These tasks 862, 864, 866 may be executed by second thread 810 using round robin scheduling. Thus, during a first time period, main thread 800 may be executing first OS 830 while second thread 810 is executing hypervisor mode tasks 862, 864, 866.

In hypervisor mode, tasks 862, 864, 866 running on second thread 810 may have unrestricted access to hardware (including the ability to disrupt main thread 800). Consequently, applications 862, 864, 866 must be trusted software. In one particular embodiment, running a trusted interpreter on second thread 810, such as the byte code interpreter of a Java virtual machine, can allow user defined programs to run on second thread 810 in hypervisor mode without verifying tasks 862, 864, 866 as trusted software. In some embodiment, just in time (JIT) compiler technology can be used to convert trusted applications 862, 864, 866 from bytecodes to machine code (e.g., Java bytecodes to PowerPC machine code).

At some point, hypervisor 820 running in main thread 800 may receive interrupt 822, for example from an I/O device. Hypervisor 820 then checks 824 to determine the intended recipient of interrupt 822. If interrupt 822 is intended for second OS 840 executing on main thread 800, hypervisor 820 initiates OS switch 872 after which the interrupt handler corresponding to interrupt 822 can be run by second OS 840. Hypervisor 820 may then initiate another OS switch 874 and resume executing first OS 830. However, because second thread 810 is executing exclusively hypervisor mode applications 862, 864, 866 there is never any need for second thread 810 to save or restore context for an OS switch. Additionally, by making second thread 810 lower priority than main thread 800, hypervisor tasks 862, 864, 866 on second thread 810 may be executed during cycles when main thread 800 would otherwise be idle.

In one embodiment, all hypervisor system calls or hcalls for hypervisor 820, may be passed to second thread 810 through a shared memory, where main thread 800 can write to the shared memory and second thread 810 can read from the shared memory. In other embodiments, internal interrupts are generated from main thread 800 to second thread 810, and these hypervisor system calls are treated as interrupts to be handled by hypervisor tasks 862, 864, 866. This strategy may be most effective for heavy weight hypervisor calls that must involve a hypervisor task to complete. In this way, the register file and cache of the main thread is not severely thrashed by handing of the hypervisor task for to the second thread.

It will be apparent to those of ordinary skill in the art that on a system capable of executing more than two threads or more than two operating systems the same approach may be utilized with similar success. For example, in a system capable of executing four threads, one thread may be the main thread, while the other three threads may be of lower priority than the main thread and each thread may be dedicated to executing one hypervisor application in hypervisor mode. Similarly, if eight secondary threads existed eight hypervisor mode functions could be independently executed on these eight threads.

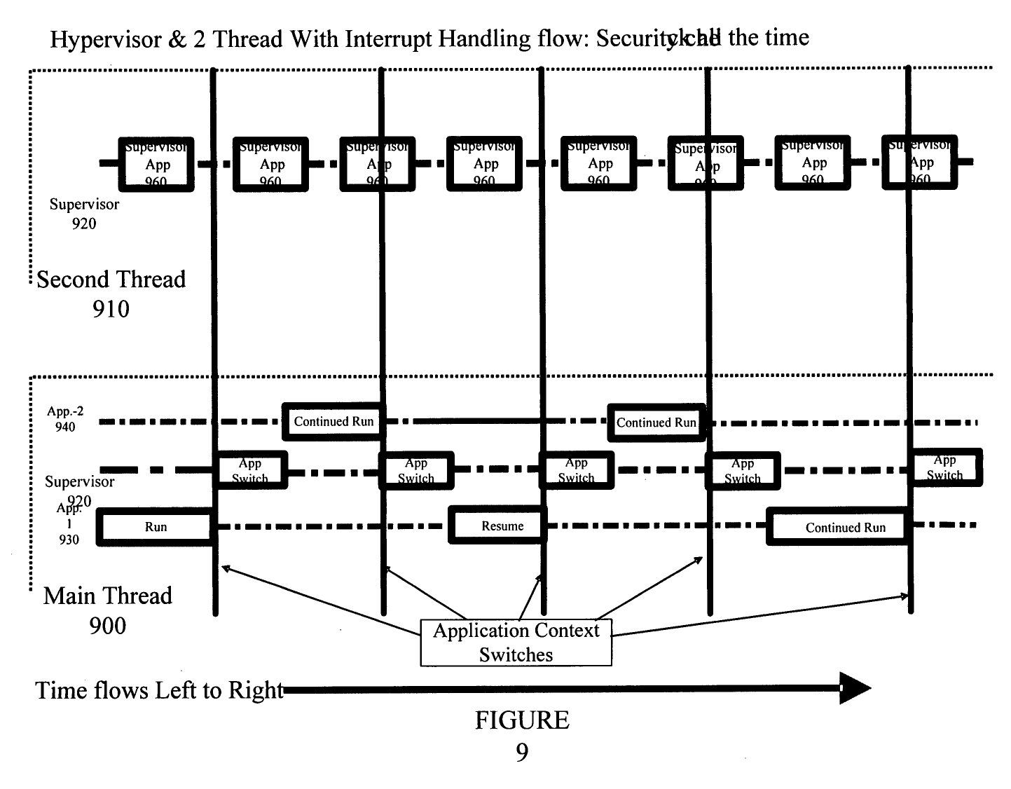

It will also be apparent that the above systems and methods may be applied to a processor without hypervisor mode, or with hypervisor mode disabled, as depicted in FIG. 9. In this embodiment, main thread 900 may run an operating system supervisor 920 and two application programs 930, 940. Second thread 910 may constantly execute in supervisor mode and run supervisor applications 960 such as syscall handling, security check, encryption, decryption, compression, decompression, interpreter, simulators etc. In this manner, second thread 910 does not have to switch problem state contexts, increasing the efficiency of the utilization of second thread 910.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A system for efficient use of secondary threads, comprising:
a first thread, wherein the first thread runs a first operating system and a second operating system; and
a second thread, wherein the second thread runs exclusively in hypervisor mode.

2. The system of claim 1, wherein the second thread is lower priority than the first thread.

3. The system of claim 2, wherein the second thread runs a hypervisor task.

4. The system of claim 3, wherein the hypervisor task comprises a security check function, an encryption function, a decryption function, a compression function, a decompression function, a reliability test function, a performance monitoring function, a debug monitoring function or a byte code interpreter.

5. The system of claim 3, wherein the first thread is operable to pass a hypervisor system call to the second thread for continued processing involving a hypervisor task.

6. The system of claim 5, further comprising a shared memory, wherein the first thread passes the hypervisor system call to the second thread for continued processing involving a hypervisor task using the shared memory.

7. The system of claim 5, wherein the first thread passes the hypervisor system call to the second thread by generating an internal interrupt from the first thread to the second thread.

8. The system of claim 3, further comprising a shared resource operable to be accessed by the first thread and the second thread, wherein the first thread has a first identification (ID) and the second thread has a second ID and access to the shared resource is controlled using the first ID or the second ID

9. A system for efficient use of secondary threads, comprising:
a first thread, wherein the first thread runs a first operating system and a second operating system; and
a second thread, wherein the second thread runs the first operating system and the second operating system, and wherein the second thread runs in hypervisor mode while an interrupt is being handled in the first thread.

10. The system of claim 9, wherein handling the interrupt includes switching between the first operating system and the second operating system.

11. The system of claim 10 wherein the second thread is lower priority than the first thread.

12. The system of claim 11, wherein the second thread runs a hypervisor task while the first thread is handling the interrupt.

13. The system of claim 12, wherein the hypervisor task comprises a security check task, an encryption task, a decryption task, a compression task, a decompression task, a reliability test task, a performance monitoring task, a debug monitoring task or byte code interpreter.

14. A method for efficient use of secondary threads, comprising:
running a first operating system on a first thread;
running a second operating system on the first thread; and
running a second thread exclusively in hypervisor mode.

15. The method of claim 14, wherein the second thread is lower priority than the first thread.

16. The method of claim 15, further comprising running a hypervisor task on the second thread.

17. The method of claim 16, wherein the hypervisor task comprises a security check task, an encryption task, a decryption task, a compression task, a decompression task, a reliability test task, a performance monitoring task, a debug monitoring task or byte code interpreter.

18. The method of claim 16, further comprising passing a hypervisor system call from the first thread to the second thread

19. The method of claim 18, wherein the hypervisor system call is passed using a shared memory.

20. The method of claim 16, wherein the hypervisor system call is passed by generating an internal interrupt from the first thread to the second thread.

21. The method of claim 16, further comprising accessing a shared resource with the first thread or the second thread, wherein the first thread has a first identification (ID) and the second thread has a second ID and accessing the shared resource is controlled using the first ID or the second ID

22. A method for efficient use of secondary threads, comprising:
running a first operating system on a first thread;
running a second operating system on the first thread;
running the first operating system on a second thread;
running the second operating system on the second thread; and
running the second thread in hypervisor mode while an interrupt is being handled in the first thread.

23. The method of claim 22, wherein handling the interrupt includes switching between the first operating system and the second operating system.

24. The method of claim 23, wherein the second thread is lower priority than the first thread.

25. The method of claim 24, further comprising running a hypervisor application on the second thread while the first thread is handling the interrupt.

26. The method of claim 25, wherein the hypervisor task comprises a security check task, an encryption task, a decryption task, a compression task, a decompression task, a reliability test task, a performance monitoring task, a debug monitoring task or byte code interpreter.

27. A computer readable medium for efficient use of secondary threads, comprising instructions translatable for:
running a first operating system on a first thread;
running a second operating system on the first thread; and
running a second thread exclusively in hypervisor mode.

28. The computer readable medium of claim 27, wherein the second thread is lower priority than the first thread.

29. The computer readable medium of claim 28, further comprising instructions translatable for running a hypervisor task on the second thread.

30. The computer readable medium of claim 29, wherein the hypervisor task comprises a security check task, an encryption task, a decryption task, a compression task, a decompression task, a reliability test task, a performance monitoring task, a debug monitoring task or byte code interpreter.

31. The computer readable medium of claim 30, further comprising instructions translatable for passing a hypervisor system call from the first thread to the second thread

32. The computer readable medium of claim 31, wherein the hypervisor system call is passed using a shared memory.

33. The computer readable medium of claim 31, wherein the hypervisor system call is passed by generating an internal interrupt from the first thread to the second thread.

34. The computer readable medium of claim 29, further comprising instructions translatable for accessing a shared resource with the first thread or the second thread, wherein the first thread has a first identification (ID) and the second thread has a second ID and accessing the shared resource is controlled using the first ID or the second ID.

35. A computer readable medium for efficient use of secondary threads, comprising instructions translatable for:
running a first operating system on a first thread;
running a second operating system on the first thread;
running the first operating system on a second thread;
running the second operating system on the second thread; and
running the second thread in hypervisor mode while an interrupt is being handled in the first thread.

36. The computer readable medium of claim 35, wherein handling the interrupt includes switching between the first operating system and the second operating system.

37. The computer readable medium of claim 36, wherein the second thread is lower priority than the first thread.

38. The computer readable medium of claim 37, further comprising instructions translatable for running a hypervisor task on the second thread while the first thread is handling the interrupt.

39. The computer readable medium of claim 38, wherein the hypervisor task comprises a security check task, an encryption task, a decryption task, a compression task, a decompression task, a reliability test task, a performance monitoring task, a debug monitoring task or byte code interpreter.
